(19) United States
(12) Patent Application Publication
(10) Pub. No.: US 2011/0270517 A1
(43) Pub. Date: Nov. 3, 2011

(54) METHOD AND APPARATUS FOR PROVIDING PERSONALIZED PRESENTATIONS BASED ON NAVIGATION INFORMATION

(75) Inventor: Vitorio Benedetti, Berlin (DE)

(73) Assignee: Nokia Corporation, Espoo (FI)

(21) Appl. No.: 12/770,367

(22) Filed: Apr. 29, 2010

(51) Int. Cl. G01C 21/00; G06F 3/01

(52) U.S. Cl. 701/201; 715/730

(57) ABSTRACT

Techniques for providing personalized presentations based on navigation information. A personalized presentation application determines one or more points of interest associated with a navigation. The personalized presentation application generates one or more presentations personal to a user of the navigation based, at least in part, on the points of interest, and the messages supplement navigation guidance information associated with the navigation. The personalized presentation application causes, at least in part, rendering of the one or more presentations.

### BACKGROUND

Service providers (e.g., wireless, cellular, Internet, content, social network, etc.) and device manufacturers are continually challenged to deliver value and convenience to consumers by, for example, providing compelling network services. Increasing number of consumers utilize navigation systems to plan their daily activity commuting, by searching for points of interest and directions for work, grocery shopping, leisure trips, etc. However, conventional navigation guidance voice prompts and text-to-speech systems provide audio distance, direction, and street information that are task-oriented, pre-defined and impersonal, regardless of the user context, such as a time of day, activities at the points of interest, etc. As a consequence, a user of conventional navigation systems typically receives impersonal audio navigation information without any personal touch. Accordingly, service providers and device manufacturers face significant technical challenges to customizing navigation information and responses to particular users.

### Some Example Embodiments

Therefore, there is a need for an approach for providing personalized presentations based on navigation information.

According to one embodiment, a method comprises determining one or more points of interest associated with a navigation. The method also comprises generating one or more presentations personal to a user of the navigation based, at least in part, on the points of interest, wherein the one or more presentations supplement navigation guidance information associated with the navigation. The method further comprises causing, at least in part, rendering of the one or more presentations.

According to another embodiment, an apparatus comprising at least one processor, and at least one memory including computer program code, the at least one memory and the computer program code configured to, with the at least one processor, cause, at least in part, the apparatus to determine one or more points of interest associated with a navigation. The apparatus is also caused to generate one or more presentations personal to a user of the navigation based, at least in part, on the points of interest, wherein the one or more presentations supplement navigation guidance information associated with the navigation. The apparatus is further causes, at least in part, rendering of the one or more presentations.

According to another embodiment, a computer-readable storage medium carrying one or more sequences of one or more instructions which, when executed by one or more processors, cause, at least in part, an apparatus to determine one or more points of interest associated with a navigation. The apparatus is also caused to generate one or more presentations personal to a user of the navigation based, at least in part, on the points of interest, wherein the one or more presentations supplement navigation guidance information associated with the navigation. The apparatus is further causes, at least in part, rendering of the one or more presentations.

According to another embodiment, an apparatus comprises means for determining one or more points of interest associated with a navigation. The apparatus also comprises means for generating one or more presentations personal to a user of the navigation based, at least in part, on the points of interest, wherein the one or more presentations supplement navigation guidance information associated with the navigation. The apparatus further comprises means for causing, at least in part, rendering of the one or more presentations.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of providing personalized presentations based on navigation information, according to one embodiment;

FIG. 2 is a conceptual diagram of the system of FIG. 1, according to one embodiment;

FIG. 3 is a diagram of the components of a personalized presentation application, according to one embodiment;

FIG. 4 is a flowchart of a process for providing personalized presentations based on navigation information, according to one embodiment;

FIG. 5 is a flowchart of a detailed process for providing personalized presentations based on navigation information, according to one embodiment;

FIG. 6 illustrates an example of a user context structure comprising a plurality of context parameters and tokens, according to one embodiment;

FIG. 7 is a diagram of a 2D digital map for navigation, according to one embodiment;

FIG. 8 is a diagram of a user interface utilized in the processes of FIGS. 4 and 5, according to one embodiment;

FIG. 9 is a diagram of hardware that can be used to implement an embodiment of the invention;

FIG. 10 is a diagram of a chip set that can be used to implement an embodiment of the invention; and

FIG. 11 is a diagram of a mobile terminal (e.g., handset) that can be used to implement an embodiment of the invention.

### DESCRIPTION OF SOME EMBODIMENTS

Examples of a method, apparatus, and computer program for providing personalized presentations based on navigation information are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

Although various embodiments are described with respect to delivering a presentation as a personalized message to the user via a navigation device, it is contemplated that the approach described herein may be used to deliver personalized presentations in any form of media (e.g., text, audio, video) via various kind of user devices, such as a mobile phone, a personal digital assistant, an audio or video player, a mobile computer, a radio, or a mobile television, a game device, a positioning device, an electronic book device, among others, alone or in some combination. The user device can stand alone, or is integrated with a vehicle. The personalized presentations can be delivered or rendered via media such as digital sound, songs, graphics, images, games, maps, point of interest information, videos (such as music videos, news clips and theatrical videos), presentations, program files or objects, any other digital media or content, or any combination thereof. The personalized presentation can be rendered and presented to a user via different methods, including displaying text, playing audio or music through speakers, displaying images on a screen or in a projection or on tangible media such as an e-book reading device, showing videos on a suitable display device with sound, graphing game or map data, or any combination thereof. In many illustrated embodiments, a navigation device is an example of a rendering device.

As used herein, the term “point of interest” (POI) refers to a specific geographic point location that an individual entity, business entity, or any legal entity may find useful or interesting. This term is used interchangeably with waypoint that is defined by a set of coordinates identifying a point in a physical space. In terrestrial navigation, these coordinates include longitude and latitude, and optionally altitude (such as for hiking, air navigation, etc.). A point of interest can be a landmark, building, sightseeing spot, museum, library, church, bridge, shopping center, restaurant, store, park, school, daycare center, community center, tunnel, airport, roadway, waterway, railway, rock formation, spring, oasis, mountain, etc.

As used herein, the term “activity” refers to one or more actions to be performed by a user during navigation, and/or at the point of interest or destination. Activity includes, for example, eating, drinking, shopping, sightseeing, watching movies, listening to a concert, dancing, performing, walking, exercising, working, schooling, among others, or even social activities like meeting, partying, having a discussion, a business lunch, among others, alone or in some combination. This activity can be deduced in any manner known in the art, such as a motion sensor, audio sniffing, calendar item information, among others, alone or in some combination. The user may be a user himself or herself, or a person of interest to the user who travelling with the user, such as a family member or friend in the same vehicle.

As used herein, the term “user context” refers to discrete context characteristics/data of a user and/or the user terminal/equipment (UE), such as a date, time, location, current activity, weather, a history of activities, etc. associated with the user. In an effort to organize the user context data, a contextual structure is inserted with instances, locations (e.g., points of interest), and events (e.g., activities) that contain possible relationships between points of interest and user activities discovered via, for instance, data-mining or other querying processes. By way of example, the contextual structure incorporates characteristics and features of an individual user's context data, such as the user's calendar, text messages, instant messages, etc. In another embodiment, user preference data is also merged into the user context structure. In particular, the contextual data elements may include location (where the user/UE is available, wherein the context information source is applicable. etc), active dates (the range of dates for which the user/UE and/or the context information source is available), sub-identifiers (each sub-identifier associated with a different location and/or applicable context information source), event type (event information associated with the user/UE), time (of the event if the user/UE involves), applicable context (in which the context information source is applicable), context source (what sensors, services, applications, etc. can provide the related contextual information), and optionally preference elements (associated with what preferences data elements), etc.

The user preferences include user information and user preference data. Typical user information elements include a user identifier (e.g., telephone number), user device model (e.g., to identify device capabilities), age, nationality, language preferences, interest areas, login credentials (to access the listed information resources of external links). In one embodiment, the preference data is automatically retrieved and/or generated by the system from the backend data and/or external information sources. In another embodiment, the preference data structure is recorded at the user device based upon user personal data, online interactions and related activities with respect to specific topics, points of interests, or locations, etc. It is contemplated that the user can define any number of preference elements and tokens as user preference data. In addition or alternatively, the system decides what parameters or attributes to choose to represent user context and/or preferences.

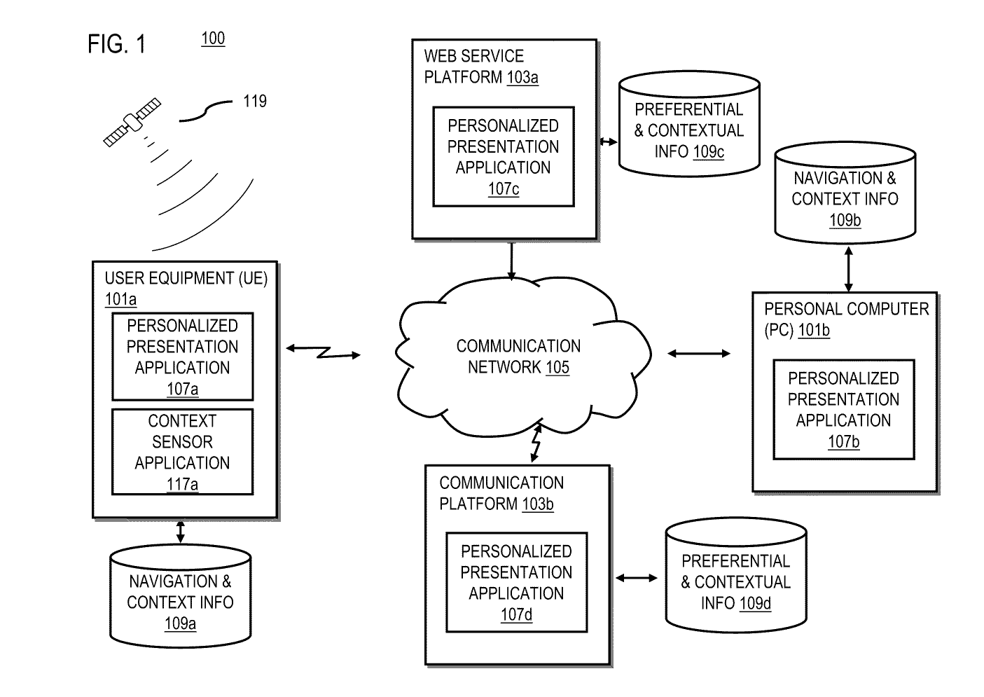

FIG. 1 is a diagram of a system 100 capable of providing personalized presentations based on navigation information, according to one embodiment. The existing navigation guidance voice prompts provides information such as the distance to travel and the travelling directions that are task-oriented, pre-defined and impersonal. For example, a pre-recorded generic and impersonal voice prompt states “In 800 feet, turn left,” states “Turn left” at the turn, and then states the same statement “You have reached your destination,” regardless of the user context. The user context can be a destination category, a time of day, a season, etc. Text-to-speech improves the voice prompts by retrieving specific street name, provides “speech synthesis” to pronounce the street name, and states in real-time “In 800 feet, turn left on Summer Street”. In the later case, the user does not have to decide whether 800 feet have been travelled, and just looks at the street sign of Summer Street to make the turn. However, the content of the synthesized statement is still impersonal.

Some navigation devices support person-to-system voice communication with voice control functions/commands to allow a user to make calls or play music. Some systems provide audible reminders recorded in the user's own voice regarding a task, such as “Picking up milk after work.” and then render the recording to the user using a voice synthesizer. However, this voice communication requires user involvement, such as determining the content of the reminder, and recording the reminder, etc.

To address these problems, the system 100 of FIG. 1 introduces the capability to aggregate points of interest of a user, to derive/infer one or more activities of the user at the points of interest, for presenting/rendering at a user device one or more personalized presentations. In one embodiment, the presentations supplement navigation guidance information associated with the navigation, to provide a personal touch to the user. By way of example, the presentations may comprise one or more messages, items (e.g., data files, applications, games, point of interest information), media objects (e.g., graphics, images, videos, sounds, songs), or a combination thereof. It is contemplated that the presentation may include any other form of information or communication to personalize or convey personalized information to a user. Further, the presentations may include information or content about people, activities, objects of interest, points of interest, context associated with the above, etc. relevant to the navigation (e.g., enjoy the cherry blossom and walking in the park with Joe). The context associated with a person may be a birthday, health, moods, clothes, preferences, etc. of the person. The context associated with an activity may be a time, location, equipment, materials, etc. of the activity. The context associated with an object of interest may be a color, size, price, position, quality, quantity, etc. of the object. The context associated with a point of interest may be weather conditions, traffic, environment, atmosphere, etc. at the point of interest. The activities are derived and/or inferred from inputted user activities and/or predicted user activities. In one embodiment, the activities are also prioritized. The highest priority activity is considered and/or used in generating the personalized presentation to present to the user. The personalized presentations may be presented to the user within a short duration prior to reaching a corresponding point of interest. The short duration may be set by the user or by the system 100, e.g., less than one minute of driving time.

The user activities at the point of interest may be derived/inferred from a POI described in a POI search query, a direction query, a navigation query, a calendar entry input by the user, a content of a text/instant message transmitted from or to the user device, etc. In another embodiment, the user activities are derived/inferred from user's activity preferences and/or activity history with respect to the POI. By way of example, when the system 100 detects that the user is arriving at a parking area of a periodically visited barber shop, the system 100 determines and renders an audio statement “Enjoy the haircut” or an image of the user with the user's favorite haircut. The user's historical and/or preferred activity information can be collected locally via the user device or retrieve externally from a server or platform.

When there are more than one business establishments or POIs (e.g., a sports good store, a restaurant, etc.) at a particular location, the system 100, for instance, generates the personalized presentation based upon the derived activities. In one example, if the user has explicitly input and/or selected a restaurant and if there is an entry for tennis shoe shopping in the user's calendar, the system 100 uses the information to customize the personalized presentation comprising a message such as: “Enjoy your meal at Buffalo's grill, and try the tennis shoes in the Sports store on the second floor.” In addition or alternatively, the system 100 can generate presentations based on media content (e.g., photographs previously taken by the user at the restaurant, recorded voices of people who have previously shared with the user at the restaurant, etc.) to personalize the experience to the user. In one embodiment, the system 100 develops and defines personalized presentations based on message sentence templates, graphical templates, or the like with respect to different POIs and/or POI categories. Optionally, the name of the POI is inserted in a personalized message or presentation. The presentation of such personalized information can advantageously create a more intimate connection between the navigation device or service and the user, thereby encouraging greater use of the service or device.

In one embodiment, the system 100 pre-records the personalized messages or predetermines the personalized content, items, media, etc. to associate with a particular navigation route or use. In another embodiment, the system 100 can dynamically generate or determine the personalized presentation using, for instance, text-to-speech technology or other dynamic synthesis algorithms to synthesize the personalized presentation or message on the fly, depending upon the technical capabilities of the user device. In one embodiment, the system 100 uses a language model to develop and define POI categories and corresponding activities as a global user context structure. The system 100 then tailors/trains the global user context structure for a particular user. The system 100 conducts user studies and surveys regarding the activities and evaluations of proper wording of the personalized messages in order to achieve the optimal user experience. The categorization of POIs and the categorization of activities per POI can be performed by researchers and/or computers via extracting information from different sources, such as social research papers and studies, surveys, censuses, public records, etc. with required granularity and precision. The system 100 may deploy some search engines to survey or data-mine user entries as well as data available in public and/or private databases to collect data categories of POIs, activities, etc.

The personalized presentations or messages may be provided in one or more selected languages. In this way, the user gets quick response at a home location as well as at a foreign location. However, the presentations in different languages can occupy storage space in the user device. When the personalized presentations are synthesized in real time and in different languages, the user device can execute the presentation synthesizing function for the languages dynamically. In one embodiment, the decision to use predetermined presentations, dynamically synthesized presentations, or a combination thereof is based on characteristics of the device such as storage capacity, processing power, available supporting functions (e.g., text-to-speech function), and the like.

In some embodiments, various aspects of the personalized presentations are configurable by the user and/or the system 100, such as the duration of the personalized presentations, or indications of the POI and/or the activity, or friends to meet at the POI, or a personalized presentation delivery timing and/or condition, or a synthesized voice to present the personalized presentation, or priorities for including various actions in the personalized presentation, or a combination thereof. The personal and humanistic detail in the personalized presentation provides a warm user experience, creating an intimate connection between the user and the system 100.

The system 100 includes the context of the user activities in the personalized presentations with respect to the navigation. By way of example, when the user reaches the POI and/or destination, the system 100 presents “Enjoy your meal at the Chinese restaurant,” “Have a good time shoe shopping,” etc. in conjunction with an photo of the user at the Chinese restaurant, rather than presenting a generic and impersonal statement such as “You have reached your destination.”

As shown in FIG. 1, the system 100 comprises a user equipment (UE) 101a connected to a personal computer 101b, a web service platform 103a, and a communication platform 103b via a communication network 105. Each of the UE 101a, the personal computer 101b, the web service platform 103a and the communication platform 103b has a personalized presentation application 107 and a database 109 for storing information. The web service platform 103a and the communication platform 103b may provide services such as music service, mapping service, video service, social networking service, content broadcasting service, etc. In particular, UE 101a and the personal computer 101b respectively have databases 109a and 109b for storing preferential and contextual information. The web service platform 103a and the communication platform 103b respectively have databases 109c and 109d for storing rule and weight value (e.g., a frequency of occurrence) information.

The user equipment (UE) 101 exchanges user context and preference information with external databases using a personalized presentation application 107a via the communication network 105. For the sake of simplicity, FIG. 1 depicts only a single UE 101 and a personal computer 101b in the system 100. However, it is contemplated that the system 100 may support any number of user terminals up to the maximum capacity of the communication network 105. For example, the network capacity may be determined based on available bandwidth, available connection points, and/or the like. As described previously with respect to the system 100, the personalized presentation application 107a uses the user context and preference information to automatically generate personalized presentations relevant to navigation POI to present at the UE 101. In the example of FIG. 1, the personalized presentation application 107a stores in the database 109a navigation data (e.g., maps, user context, preference, and/or resource information), a user context structure, a sentence catalog, etc. The user context structure maps user activities to POIs and POI categories, and the sentence catalog matches or otherwise associates personalized message sentences to activities. By way of example, the user enters an address for directions. The UE 101 searches the navigation data for POIs located at the address, and determines that the POI is, for example, an Italian restaurant. The UE 101 maps the POI to corresponding activities (e.g., eating) in the user context structure, and then maps the one or more activates to at least one personalized message sentence (e.g., “Enjoy your meal”) stored in the sentence catalog.

In another embodiment, one or more personalized message sentences may be provided locally at the UE 101. In yet another embodiment, the UE 101 retrieves and presents information (e.g., web pages, documents, files, media, etc.) of the POI from one or more external databases.

The UE 101 also includes a context sensor application 117a for detecting or sensing one or more contextual characteristics (e.g., time, location, current activity, etc.) associated with the UE 101. This contextual information can then be transmitted to the personalized presentation application 107a to construct/enhance the user context structure for use in generating personalized presentations. By way of example, the context sensor application 117a may include one or more global positioning system (GPS) receivers for determining a location, an accelerometer to determine a movement or tilt angle, a magnetometer to determine a directional heading, a microphone to determine ambient noise, a light sensor, a camera, and/or the like. In addition or alternatively, the personalized presentation application 107a may obtain contextual information from one or more of the web services (e.g., a weather service, a location tracking service, social network service, etc.).

By way of example, the UE 101 is any type of mobile terminal, fixed terminal, or portable terminal including mobile handsets, mobile phones, mobile communication devices, stations, units, devices, multimedia tablets, digital book readers, game devices, audio/video players, digital cameras/camcorders, positioning device, televisions, radio broadcasting receivers, Internet nodes, communicators, desktop computers, laptop computers, Personal Digital Assistants (Pads), or any combination thereof. Under this scenario, the UE 101 employs wireless links (e.g., cellular radio links) to access the communication network 105 and/or the personalized presentation application 107a. In addition or alternatively, it is contemplated that the UE 101 may also employ wired connections (e.g., wired Ethernet connections) to the network 105 and/or the personalized presentation application 107a. It is also contemplated that the UEs 101a, 101b can support any type of interface to the user (such as “wearable” circuitry, etc.).

Additionally, in certain embodiments, the communication network 105 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), a public data network (e.g., the Internet), or any other suitable packet-switched network, such as a commercially owned, proprietary packet-switched network, e.g., a proprietary cable or fiber-optic network. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), satellite, mobile ad-hoc network (MANET), and the like.

By way of example, the UE 101a, the personal computer 101b, the web service platform 103a and the communication platform 103b communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application headers (layer 5, layer 6 and layer 7) as defined by the OSI Reference Model.

In one embodiment, the personalized presentation application 107a of the UE 101a and the personalized presentation application 107c of the web service platform 103a may interact with each other according to a client-server model. According to the client-server model, a client process sends a message including a request to a server process, and the server process responds by providing a service (e.g., providing map information). The server process may also return a message with a response to the client process. Often the client process and server process execute on different computer devices, called hosts, and communicate via a network using one or more protocols for network communications. The term “server” is conventionally used to refer to the process that provides the service, or the host computer on which the process operates. Similarly, the term “client” is conventionally used to refer to the process that makes the request, or the host computer on which the process operates. As used herein, the terms “client” and “server” refer to the processes, rather than the host computers, unless otherwise clear from the context. In addition, the process performed by a server can be broken up to run as multiple processes on multiple hosts (sometimes called tiers) for reasons that include reliability, scalability, and redundancy, among others.

It is noted that the UE 101 may track user's position through satellites 119, such as the United States' Global Positioning System (GPS) satellites, Russia's Global Navigation Satellite System (GLONASS) satellites, the Chinese Compass navigation system, the Galileo positioning system of the European Union (EU), pseudolites, etc. In one embodiment, the UE 101 uses artificial intelligence software to communicate that information over broad distances from the user's location to the satellite, and then back to the UE 101.

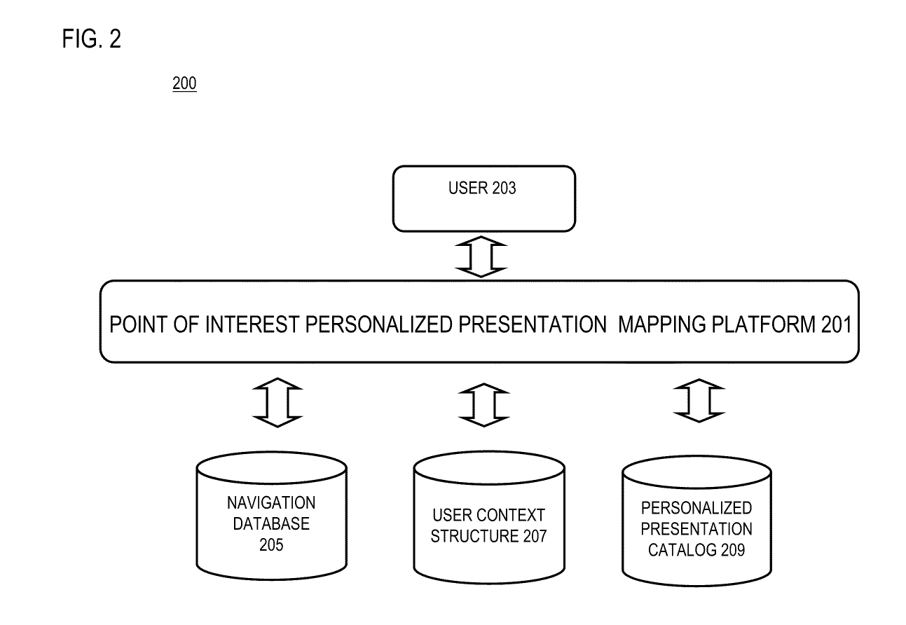

FIG. 2 is a conceptual diagram 200 of the system of FIG. 1, according to one embodiment. In one embodiment, the system 100 deploys a point of interest personalized presentation mapping platform 201 that generates personalized presentations for navigation points of interest of a user 203 based upon a user navigation database 205, a user context structure 207, a personalized presentation catalog 209, etc.

The user navigation database 205 includes historical and contextual navigation data of a user at different time points. In one embodiment, the historical and contextual navigation data is automatically recorded at the UE 101a with respect to user personal data, navigation, and related activities, points of interests, etc. The historical and contextual navigation data is stored and/or cached locally at the UE 101a. In another embodiment, the data is stored at the web service platform 103a and/or other external databases.

By way of example, the elements of the historical and contextual navigation data include location (where the user/UE is applicable, wherein a POI category is applicable. etc), active dates (the range of dates for which the user/UE and/or the context information source is available), sub-identifiers (each sub-identifier associated with a different location and/or applicable POI category), event type (event information associated with the user/UE), time (of the event if the user/UE involves), applicable activity (in which the activity is applicable to the POI category and/or POI), context source (what sensors, services, applications, etc. can provide the related contextual information), and optionally preference elements (associated with what preferences data elements), etc.

The system 100 analyzes the contextual characteristics (e.g., time, location, current activity, historical activity, etc.) referenced in the POIs to construct the user context structure 207 using, for instance, data mining techniques (e.g., word parsing followed by a probabilistic analysis of the parsed words to categorize the POIs and corresponding activities) to reflect the activity context of the user. Activity tokens matching POI-related terms are included in the user context structure 207. Inclusion in the context structure means that a token describes a context condition (e.g., a time, place, location, activity, etc.), a context source (e.g., a service or sensor that provides that contextual characteristics to determine a particular context and activity condition), and/or other context-related information associated with the user. The same data mining techniques are used to determine and analyze information associated with user preference characteristics (e.g., food, clothing, housing, vehicles, learning, entertainments, etc.) to enhance the user context structure 207.

By way of example, prior to leaving a starting location (e.g., home, office, etc.), the user uses the UE 101a or the PC 101b to search in the navigation database 205 for one or more POIs (e.g., park, restaurant, bookstore, grocery shopping, etc.) and to schedule the POIs in one trip or navigation. In one embodiment, the assembled navigation data is then transported via the UE 101a. In another embodiment, the assembled navigation data is transferred from the PC 101b to the UE 101a, or is synchronized with a navigation system integrated in the user's vehicle.

When the user starts the vehicle, the on-board navigation device (e.g., the UE 101a, etc.) may uses context data (e.g., weather forecast data from the web service platform 103a, temperature data from an on-board thermometer, etc) to generate a personalized presentation, such as “The weather is nice outside. Enjoy the trip.”

During the navigation, the on-board navigation device may monitor predetermined triggering events that trigger personalized presentations during the navigation. The triggering events include a traffic jam, car accident, road work, severe weather (e.g., heavy rain/snow, etc), home/office alarm, emergency notice, etc. In one embodiment, the on-board navigation device subscribes to the web service platform 103a for information on traffic jams, car accidents, road work, severe weather, etc., and determines whether such triggering events occur on the navigation route. If so, the on-board navigation device automatically considers the triggering event on the route in conjunction with context information to generate one or more personalized presentations. By way of example, the on-board navigation device automatically considers a traffic jam in conjunction with a calendar entry of jogging, and presents to the user a statement: “The traffic jam on the route to the park may cause delay if you plan to hike in the park. Do you want to travel on an alternative route?”

In another embodiment, the on-board navigation device detects triggering events via sensors built in the device or in the vehicle. For example, when the vehicle arrives at the park, the on-board navigation device detects high humidity, and generates a personalized message: “It may rain in the park shortly. Please bring a rain coat. Enjoy the hike.”

It is noted that a considerable amount of relevant user activities actually happen when user is offline (e.g., not connected into Internet). Therefore, the system 100 uses the capabilities of the UE 101 and the on-board navigation device to record and track the offline activities, such as the user's visits to the point of interest (e.g., a community center, office, supermarket, restaurant, park, museum, etc.). The system 100 may track user's offline activities including (1) GPS data indicating the user's actual visits to a POI (e.g., a particular restaurant), (2) bills/receipts charged for the user's actual visits to the restaurant, etc., (3) mentioning the restaurant by the user in the user's calendar appointments, (4) calling by the user inside the restaurant, (5) voting by the user the restaurant as excellent (e.g. In a survey), (6) media items (articles, music, video, photos, etc. posted in blogs on web pages, etc.) created by the user regarding the restaurant, etc. The system 100 may look for the name of the restaurant mentioned in text or audio messages created by the user. In this case, the system 100 determines which restaurant is represented in articles, music, video, photos by looking via a GPS position and heading data in the data files. The system 100 may conduct content analysis of the communications (e.g., text or audio messages, graphics, content items, media files, etc.) of the user to look for expressions of personal importance towards the restaurant, such as “I really love the Italian Restaurant, I eat there as often as I can”, “I take every opportunity to invite people to dine at the Italian Restaurant,” etc. The system 100 may explore associations between the user and the restaurant by accessing databases storing data on where the user lives in, works in, has a membership to (e.g., a dining club), as well as databases storing data on where (the restaurants) the user's friends or contacts live in, work in, have a membership to, etc. The system 100 may collect raw user activity and group behavior information with respect to POIs to construct the user context structure 207.

The personalized presentation catalog 209 may be organized by user activity and/or by POI. The system 100 collects various heuristic sentences, files, images, graphics, etc. that are frequently used in conjunction or otherwise associated with navigation, POIs, and activities frequently occurring at the POIs. In this embodiment, the standard phrasing or pre-formatted presentation approach is used to accelerate the processing speed and reduce workload. In another embodiment, the system 100 has the capacity to produce a personalized presentation dynamically from scratch.

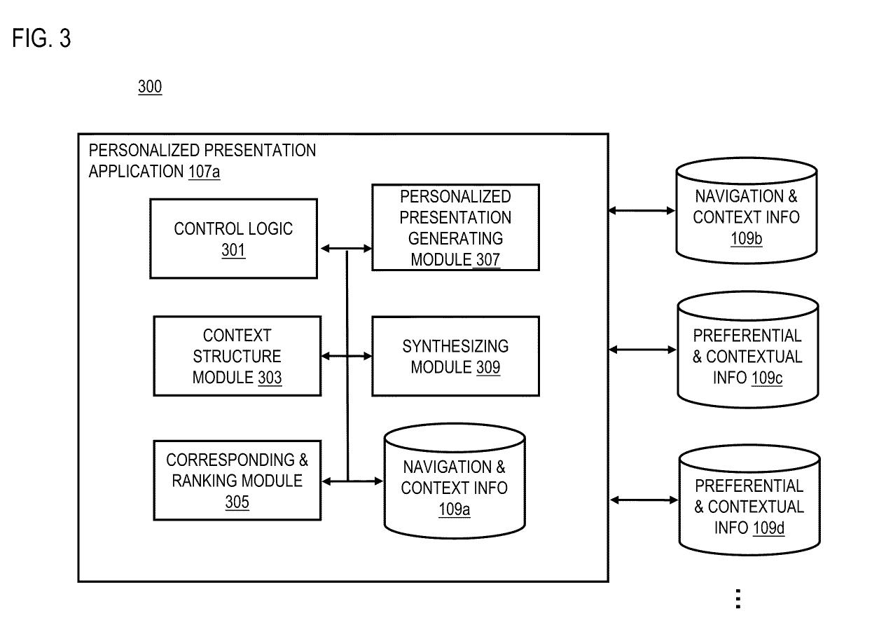

FIG. 3 is a diagram 300 of the components of a personalized presentation application, according to one embodiment. By way of example, the personalized presentation application 107a of the UE 101a includes one or more components for suggesting information resources based on contextual, preferential and group behavior information. It is contemplated that the functions of these components may be combined in one or more components or performed by other components of equivalent functionality. In this embodiment, the personalized presentation application 107a includes at least a control logic 301 which executes at least one algorithm for performing functions of the personalized presentation application 107a. For example, the control logic 301 interacts with a context structure module 303 to create and/or update a context structure of the user. In another embodiment, the context structure module 303 interacts with one or more external databases and cloud computing to apply user context data to a user context structure stored therein, and then receives the application results.

In another embodiment, the context structure module 303 imports a user context structure from an external database, and then applies the user context data to the user context structure at the user device either with or without deploying cloud computing. After updating the user context structure, and the context structure module 303 may save it back to the external database. In yet another embodiment, the context structure module 303 imports raw user context data from one or more external databases, and then constructs the user context structure at the user device on the fly, either with or without deploying cloud computing.

The control logic 301 also interacts with a corresponding and ranking module 305 to apply user navigation data (e.g., a trip to run errands) to the context structure, and to rank points of interest (e.g., a library, supermarket, gas station, etc.) as well as potential activities (e.g., retuning books, grocery shopping, filling up gas tank and buying engine oils, etc.) at each of the POIs. The POIs can be specified by the users before and/or during the navigation. If the user does not specify the points of interest, the corresponding and ranking module 305 maps the route(s) of the trip to points of interest, ranks the POIs based upon other user context information (e.g., time, navigation history, user preferences, user calendar, etc.), and then selects some of the POIs to offer personalized presentations. When there are two or more points of interest at one location, the corresponding and ranking module 305 further uses the other user context information to determine the most likely point of interest at the location.

When the user takes an unscheduled stop (e.g., at a POI), the corresponding and ranking module 305 matches the stop location to a local and/or external map database, in order to determine the nature of the stop and to determine one or more potential activities associated with the stop.

For each selected POI, the corresponding and ranking module 305 matches potential activities and their respective token weight values (e.g., a frequency of occurrence) in the user contexture structure to each selected POI.

In one embodiment, the corresponding and ranking module 305 evaluates the probabilities of possible activities matching the POI based upon additional data. The additional data may include user preferences, user historical navigation data, calendar data, recent text messages, instant messages, etc, to determine an appropriate personalized presentation. In one embodiment, the corresponding and ranking module 305 is an artificial intelligent agent designed to rank the potential points of interest and/or to rank activities occurring at the POIs. In general, the more recent the additional data is, the more relevant it is with respect to the POIs and potential activities. By way of example, a short message just received by the user terminal “See you in the movie theater at 5 pm,” is more relevant to calendar entries of the user's routine jogging at 5 pm.

In certain embodiments, the personalized presentation application 107a of the UE 101 interacts with the personalized presentation application 107c of the web service platform 103a to retrieve the addition data for the corresponding and ranking module 305. The personalized presentation application 107a may receive from the web service platform 103a weight values assigned by the users and/or embedded in the user context structure.

By way of example, the user always drinks soda in a mall, purchases new shoes eight out of ten visits to a mall, and uses an ATM machine every other visits to a mall. In this example, the weight value for drinking soda in a mall is 10, which corresponds to a frequency of occurrence of 100%. The weight value for purchasing new shoes in a mall is 8, which corresponds to a frequency of occurrence of 80%. The weight value for using an ATM machine in a mall is 5, which corresponds to a frequency of occurrence of 50%. Therefore, the ranking for activities in a mall for this user from high to low is: drinking soda, purchasing new shoes, and using an ATM machine. When two points of interest or two activities have an identical weight value, a number of times that they were used by the personalized presentation application 107a to generate a personalized presentation is used as a tie breaker.

The control logic 301 also interacts with a personalized presentation generating module 307 to generate one or more personalized presentations for each selected POI. In one embodiment, the control logic 301 uses a weight value (e.g., 6) as a cut-off point to select potential activities. Referring back to the mall example, only drinking soda and purchasing new shoes have weight values more than 5. Therefore, the personalized presentation generating module 307 generates two personalized presentations or a combine personalized presentation for the two activities for the user at a mall. By way of example, the combined personalized message is: “Enjoy the soda and shoe shopping in the mall.”

The control logic 301 also interacts with a synthesizing module 309 to convert the generated personalized message text into human speech. The synthesizing module 309 generates synthetic speech waveforms via concatenative synthesis (e.g., concatenating or stringing together of segments of recorded speech), formant synthesis (e.g., outputting synthesized speech using an acoustic model), etc. In one embodiment, the synthesizing module 309 assigns phonetic transcriptions to each word, and divides and marks the text into prosodic units, like phrases, clauses, and sentences, and then the synthesizing module 309 converts the symbolic linguistic representation into sound. In another embodiment, the synthesizing module 309 pre-records one or more phrases and/or words and then assembles prerecorded phrases and inserted words on the fly to generate and/or render the personalized presentations.

The synthesizing module 309 may use a number of different extensible markup languages (XMLs) to annotate texts for speech synthesis, and defines tags which control the way words, numbers, and sentences are reproduced to render the personalized presentations. The XML markup languages may be Java Speech Markup Language (JSML), SABLE, Speech Synthesis Markup Language (SSML), etc. SABLE was developed as an informal joint project between Sun Microsystems, AT&T, Bell Labs and Edinburgh University (the initial letters of each make the word “SABLE”). Speech synthesis markup languages are distinguished from dialogue markup languages (e.g., VoiceXML). Dialogue markup languages include tags related to speech recognition, dialogue management and touchtone dialing, in addition to text-to-speech markup.

There are commercially available synthesizers that allow the speech to emulate the audible characteristics of any person's voice for which an adequate sample is available, including voices of celebrities. The type of technology used for synthesis enables personalization using the parameters of any given person's voice.

In one embodiment, the text converted to speech is spoken by a chosen voice of, for example, a celebrity, etc. Thus, converting text into speech further comprises converting text to a selected voice, such as a celebrity voice. An advantage of the selected or celebrity voice is that it is often as rapid to convert text to speech using any voice, and yet may be more desirable for more users, and therefore creates a greater demand for the system 100 and makes better use of available network resources. Thus a premium service can be established based on the celebrity voice. Use of celebrity voice in text to speech conversion is one example means to achieve this advantage. In some embodiments, the selected voice is the user's voice or a voice of a non-celebrity for whom a voice sample is available.

In some embodiments, a personalized presentation is embedded with background sounds, such as music and other sounds by determining certain semantic elements in the personalized presentation. For example, a music piece embedded as background is chosen based upon the point of interest, activity, and other parameters in the personalized presentation. By way of example, a personalized presentation of “Enjoy the Hotel and sunny California” is embedded with the song “Hotel California” and an image of the hotel as background. The image of the hotel may contain the user, a friend or relative of the user, or any person the user is related or interested (such as the user's favorite singer, etc.). The image of the hotel may contain an object the user is related or interested, such as the user's favorite view, chair, painting, store, walkway, etc.

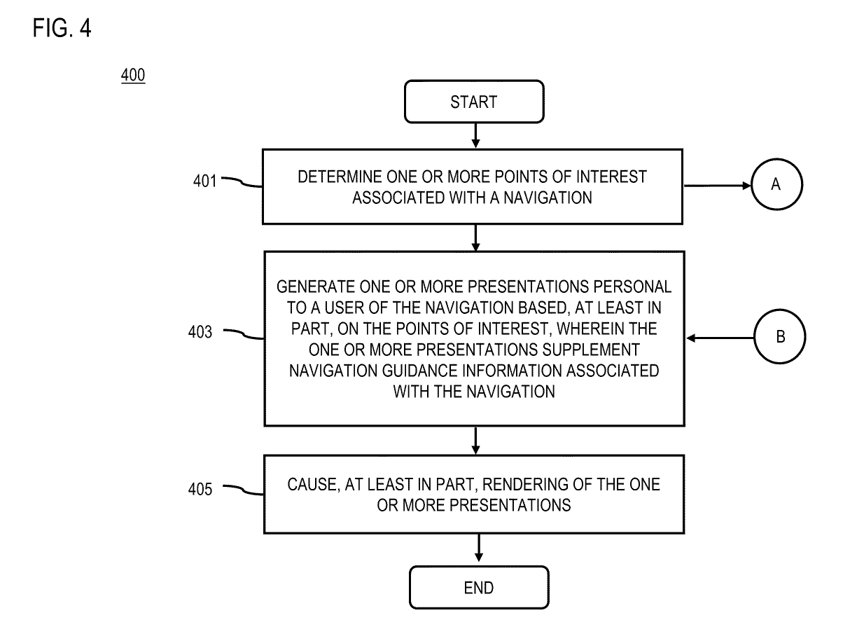

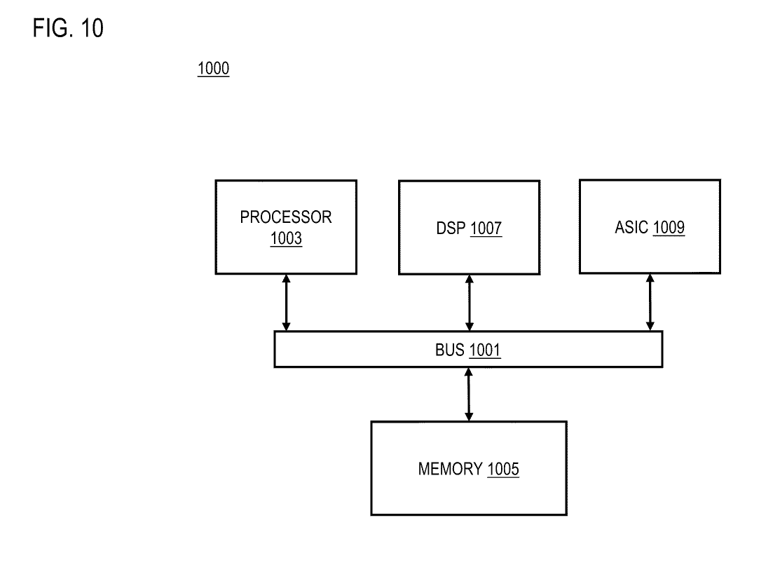

FIG. 4 is a flowchart of a process 400 for providing personalized presentations based on navigation information, according to one embodiment. In one embodiment, the personalized presentation application 107a of the UE 101 performs the process 400 of FIG. 4 and is implemented in, for instance, a chip set including a processor and a memory as shown in FIG. 10. In Step 401, the personalized presentation application 107a determines one or more points of interest associated with a navigation (e.g., by a user). The navigation may be planned at any time before the trip. In one embodiment, the user plans the trip years, months, weeks, days, hours, minutes, seconds, etc. before the time of the trip via the UE 101a, PC 101b, or other consumer electronics. In another embodiment, the user plans the trip on the go.

If the device used for planning navigation is mobile, the user can travel with the mobile device. The user can also plug the planning device into the vehicle, when the device is built to be work on board in the vehicle. If the planning device is not mobile (e.g., the PC 101b), the user will synchronize the data of the navigation to a mobile device or a built-in device in the vehicle, before taking the trip. The data synchronization can be carried out via all forms of connections (e.g., wire, USB, memory stick/card, CD, etc.) and/or communication (internet, wireless, Bluetooth, IR, etc.).

In one embodiment, the navigation includes one or more routes connecting between points of interest (e.g., a park, restaurant, shopping mall, etc.). In addition, the ways to travel between the points of interest may include different modes of travel and/or vehicles. By way of example, modes of travel may include walking, hiking, jogging, etc. The vehicles may include a bicycle, car, bus, taxi, motorcycle, truck, van, trailer, train, ship, boat, submarine, aircraft, etc. The navigation may be planned for one or more users, such as a family, a group of friends, a tour group, etc. The navigation may also be planned by one user or by a group of users jointly and include any number or combination of locations, points of interests, geographical regions, geographical features, and the like.

The personalized presentation application 107a generates one or more presentations personal to a user of the navigation based, at least in part, on the points of interest (Step 403). The presentations supplement navigation guidance information associated with the navigation. By way of example, the personalized presentation application 107a matches one or more potential user activities (e.g., meeting and eating with friends, etc.) to one or more points of interest (e.g., a restaurant) associated with the navigation. The personalized presentation application 107a generates a personalized presentation (e.g., “Enjoy the food with your friends at the ZZZ restaurant” with an image of the user with friends at the ZZZ restaurant) based upon at least one of the potential user activities. Personalized presentation is communicated by a user device to intentionally make its presence known to the user, to convey attention and care to the user. The personalized presentations (such as a greeting) can be culture-specific and may change within a culture depending on the context structure used. The personalized presentation application 107a causes, at least in part, rendering of the one or more presentations (Step 407), such as 100 feet away from the restaurant, or right at the parking lot of the restaurant, etc.

In certain embodiments, it is contemplated that the personalized may be presented during the navigation as described above or at another period of time. By way of example, the personalized presentation may be displayed to the user after the navigation has been completed. In this way, once a user has navigated to and finished dining at a favorite restaurant, the presentation application 107a may display a welcoming personalized message stating “I hope you enjoyed your dinner the restaurant ZZZ, it's your favorite” to further personalize the experience for the user on resuming the navigation device and corresponding presentation application 107a.

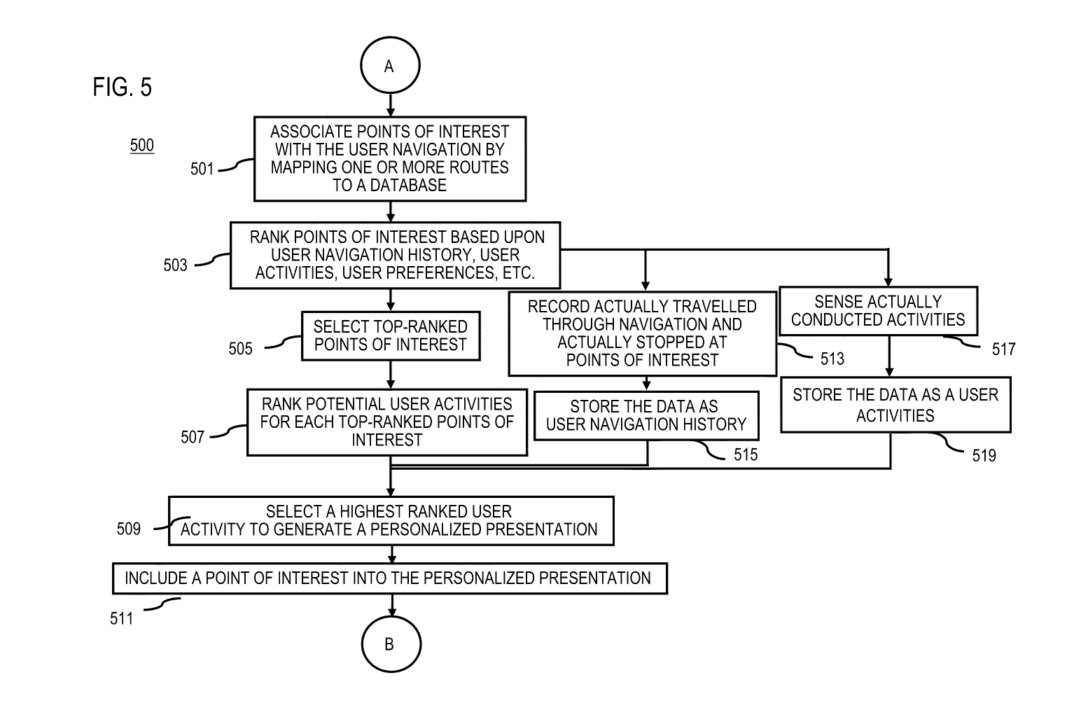

FIG. 5 is a flowchart of a detailed process 500 for providing personalized presentations based on navigation information, according to one embodiment. The process 500 occurs between the step 401 and Step 403 of FIG. 4, as marked by a processing point A and a processing point B. In one embodiment, the personalized presentation application 107a of the UE 101 performs the process 500 of FIG. 5 and is implemented in, for instance, a chip set including a processor and a memory as shown in FIG. 10. In Step 501, the personalized presentation application 107a associates one or more points of interest (e.g., a park, mall, etc.) with the navigation by mapping one or more routes (among the POIs) of the navigation to the navigation and context information database 109a and retrieves points of interest on the routes from the database 109a. In another embodiment, the personalized presentation application 107a accesses one or more external databases (e.g., the databases of the web service platform 103a or of the communication platform 103b, etc.) for the route information.

The personalized presentation application 107a ranks the retrieved points of interest based upon user navigation history, user activities occurred at the one or more points of interest, user preferences, or a combination thereof (Step 503). The information of user navigation history (e.g., prior trips), user activities occurred at the one or more the points of interest (e.g., a park, mall, etc.), user preferences (e.g., jogging in a particular park, shopping in a certain mall, etc.) may be available on the UE 101a, or at one or more external databases to be retrieved on the fly.

The personalized presentation application 107a selects a predetermined number (e.g., 5) of the top-ranked points of interest for generating personalized presentations (Step 505). In one embodiment, the personalized presentations relate to a characteristic of the points of the interest, one or more potential activities conducted at the points of interest, the user, or a combination thereof. The personalized presentation application 107a ranks the potential user activities (e.g., withdrawing cash, borrowing money, etc.) at each of the top-ranked points of interest (e.g., a bank) based upon previously user activities (e.g., depositing checks) occurred at the each point of interest, user preferences (e.g., exchanging coins for washing/drying machines), user calendars (e.g., biweekly pay days), recent text messages (e.g., “Joe, can you get $200 cash on your way back?”), recent instant messages (“Please remember to deposit your pay check.”), or a combination thereof (Step 507).

In one embodiment, the personalized presentation application 107a selects a highest ranked or a predetermined number of the highest ranked user activities (e.g., refinancing home mortgage) for generating the personalized presentation (e.g., “Good luck for getting a loan with a lower interest rate.”) for the each point of interest (e.g., a bank) (Step 509). In another embodiment, the personalized presentation application 107a includes a point of interest (e.g., a bank) corresponding to the at least one of the potential user activities into the personalized presentation (e.g., “Good luck for getting a lower interest rate at the Bank.”) (Step 511).

The personalized presentation application 107a records data of navigation (e.g., a Las Vegas trip) that the user actually travels through as well as points of interest (e.g., the Hoover Dam, casinos, etc.) that user actually stops at (Step 513). The personalized presentation application 107a stores the data as a part of the user navigation history (Step 515). In another embodiment, the personalized presentation application 107a senses data of activities (e.g., hiking at 3 miles per hours in hot and dry weather conditions) that the user actually conducts at the points of interest (e.g., the Valley of Fire State Park) that user actually stops at (Step 517).

By way of example, the personalized presentation application 107a monitors what activities the user is engaged at the point of interest, and performs advanced data mining for additional individual preferences and context. The personalized presentation application 107a then combines the information into the user context structure to generate personalized presentations. The personalized presentation application 107a stores the activity data locally and/or at one or more external databases as a part of the user activities occurred at the points of interest (Step 519).

As shown in FIG. 5, the sub-process of recording navigation and point of interest (Steps 513 and 515) and the sub-process of user activity sensing (Steps 517, 519) can occur concurrently during the navigation with the main process of generating the personalized presentation (Steps 501-511). In another embodiment, these processes may occur sequentially or not synchronized at all.

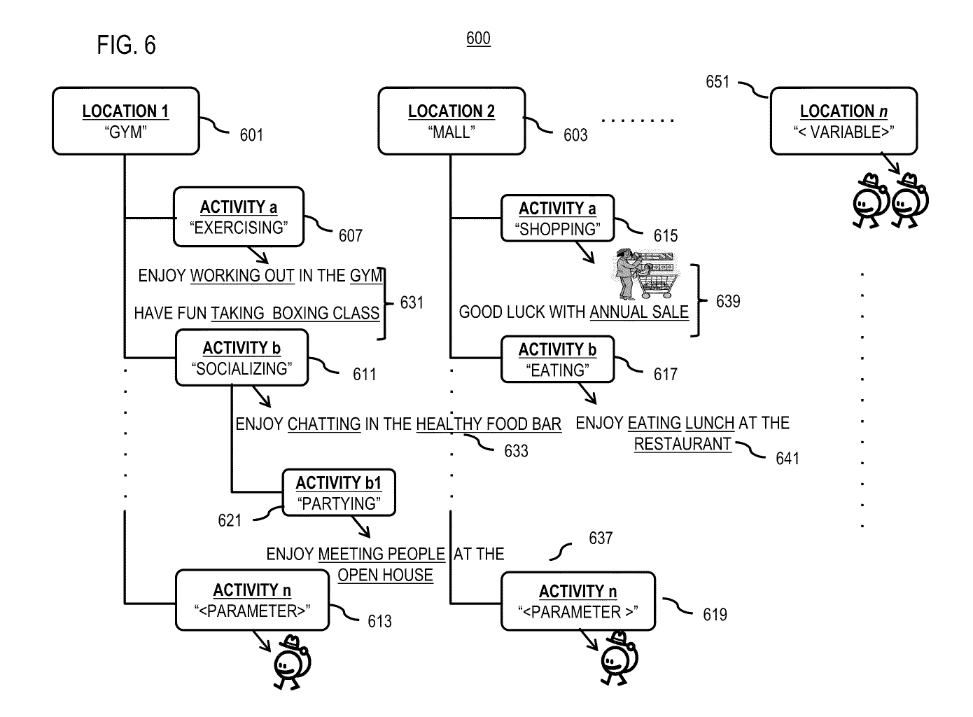

FIG. 6 illustrates an example of a user context structure 600 comprising a plurality of context parameters and tokens, according to one embodiment. The user context structure 600 takes into account points of interest (e.g., locations), user activities (e.g., exercising, shopping, etc.) at the points of interest as a basis for generating personalized presentations from preformatted sentences, messages, items, media files, etc. Examples of preformatted personalized message sentences including context parameters of location, activity, and person/people are listed Table 1.

TABLE 1

“Enjoy activity.”
“Enjoy activity at/in location.”
“Enjoy activity at/in location with person/people.”
“Have fun activity.”
“Have fun activity at/in location.”
“Have fun activity at/in location with person/people.”
“Good luck with activity.”
“Good luck with activity at/in location.”
“Good luck with activity at/in location with person/people.”

Additional context parameters, such as time (e.g., morning, noon, evening, 3 pm, April 15, next hour, etc), temperature (e.g., hot, warm, cool, cold, over 90° F., etc.), weather (e.g., sunny, cloudy, rainy, windy, snowy, etc.) etc., can be included in the formatted presentations (e.g., sentences, graphics, sounds, media files, etc.). In addition, two or more personalized presentations can be rendered to the user together when the user plans to do a plurality of activities at (or near) the same point of interest. By way of example, the personalized presentation application 107a uses the user context structure 600 and preformatted sentences to generate a personalized message: “Enjoy jogging in the park with Joe this morning while it is cool. It will start raining in 2 hours, so please take raingear.” At the same time, the personalized presentation application 107a displays a photo of Joe attending a marathon.

The personalized message sentences, graphics, images, etc, are mapped within the user context structure 600 that include the above-described context parameters and relevant language tokens reflecting current or coming context of the user at corresponding points of interest. When the mapping process is implemented based upon all tokens in the user context structure 600, the results will be more comprehensive. When the process is implemented based upon only tokens that constitute a current user context structure (e.g., a part of the structure 600), the process is accelerated. The user context structure 600 may contain all spoken languages, or just selected one or more languages.

To evaluate competing activity parameters (e.g., exercising, socializing, etc) at the same point of interest (e.g., a gym), the personalized presentation application 107a generates token weight value (e.g., a frequency of occurrence) in a dynamic manner via a set of weight values while maintaining the point of interest personalized presentation mapping platform 201 generic. The likely activities at the gym may be extracted from the user context structure 600 by applying one or more weight values to all extracted context data elements in the structure 600, such as user activity history, user preferences, user calendar, recent text messages, recent instant message, etc., and then selecting the likely activities. As mentioned, the structure 600 is developed from a global user context structure based upon user studies and behavior studies.

The user content structure 600 is implemented as a data file, organized in accordance with a data structure so as to be readily interpreted, analyzed, reconstructed or deconstructed. Within this data file are one or more representative topics of activities, wherein each topic is a composite token. As such, the set of tokens comprising the user activities structure define a fixed, but expandable, set of user activity topics. For the sake of clarity, the term “token” and “topic” will be recognized as synonymous terms, as the computational or semantic processing of the data file ultimately results in abstraction of the topics into one or more tokens.

Generally, a token can be a keyword, an operator, punctuation mark or any combination of words and/or characters comprising an input string or input document. In the context of FIG. 6, each top level topic 601, 603 through 661 represent a pre-defined number of location tokens—e.g., 60 top level location tokens. Hence, each descriptor variable of a given token is semantically recognized as a noun/activity, e.g., “exercising,” “shopping,” etc. Each topic is further divided into one or more subclasses for further organization into subtopics. The user context structure 600 is thus hierarchically arranged, such that a defined/controlled number of top level location tokens 601, 603 and 661 have respective activity categories 607, 611, 613, 615, 617 and 619. Activities of a given location 601, 603 and 561 within the hierarchy can go down multiple depths and levels (further activity subcategories 621), representing, for instance, anywhere between 10 to 20 tokens depending on the nature of the activities category. The tokens are inserted into preformatted personalized message sentences to generate personalized message sentences 631, 633, 637, 639, and 641.

The user context structure 600 of location topics and activity categories may represent a set of at least 7500 tokens or topics to be included into preformatted personalized message sentences. The categorization of activities per location can be manually performed by researchers and/or computers by extracting the information from different sources of information, such as social research papers and studies, surveys, censuses, public records, etc. with required granularity and precision. Furthermore, the hypothetically presented number of 7500 tokens is by way of example, not limitation. The number of tokens will reduce as the granularity of topics rise and as new genres get identified or refined per user over time.

With reference again to FIG. 6, for example, for Token 607 of the behavior “EXERCISING (in the gym),” the personalized presentation application 107a assembles two associated personalized message sentences: “Enjoy working out in the gym” “Have fun taking boxing class” 631, which pertain to the activity of exercising and the location/gym. Alternatively or concurrently, personalized presentation may include other content items, graphics, images, files, applications, etc. that are presented to the user. Token 611 of the activity “SOCILIZING (in the gym),” has one sub-Token 521 for activity “PARTYING (in the gym).” A personalized message sentence for “SOCILIZING” can be assembled as “Enjoy chatting in the healthy food bar,” and a personalized message sentence for “PARTYING” can be assembled as “Enjoy meeting people at the open house.” The additional information of “the healthy food bar” and “at the open house” is extracted from the user context structure 600. In the first example, the user activity history shows that the user often consume food at the healthy food bar after working out at the gym. In the second example, the user's instant message box has several messages from the gym with invitations to the open house of the gym on that day.

For Token 615 of activity “SHOPPING (in the mall),” the personalized presentation application 107a assembles two personalized presentation: an image of the user shopping for clothes and a message of “Good luck with annual sale” 639, which pertain to the activity of shopping and the location/mall. For Token 617 of the activity “EATING (in the mall),” the personalized presentation application 107a assembles a personalized message sentence “Enjoy eating lunch in the restaurant.”

As shown in the above-described embodiments, the personalized presentation application 107a extracts a set of reference tokens from the user context structure 600 serving as a basis for applying tokens onto the preformatted personalized message sentences or using the tokens to retrieve personalized graphics, images, etc. per user. The context tokens of locations, activities, etc. extracted from the user context structure 600 infuse user-specific information into the personalized presentations thereby deriving contextually accurate and relevant personalized presentations for the user. Personalized presentations can be expressed both audibly and visually, and often involve a combination of the two. In particular, the personalized presentation application 107a searches the user context structure 600 for POI categories and corresponding activities to include in preformatted personalized message sentences, graphics, videos, etc.

User studies regarding the response to the activities and evaluation of the proper wording, designs, contents, etc. of the personalized presentations are conducted in order to achieve the optimal user experience. The categorization of POIs and the categorization of activities per POI can be performed by researchers and/or computers by extracting the information from different sources of information, such as social research papers and studies, surveys, censuses, public records, etc. with required granularity and precision. Some search engines are deployed to survey or mine user entries and data available in public and/or private databases to collect data categories of POIs, activities, etc.

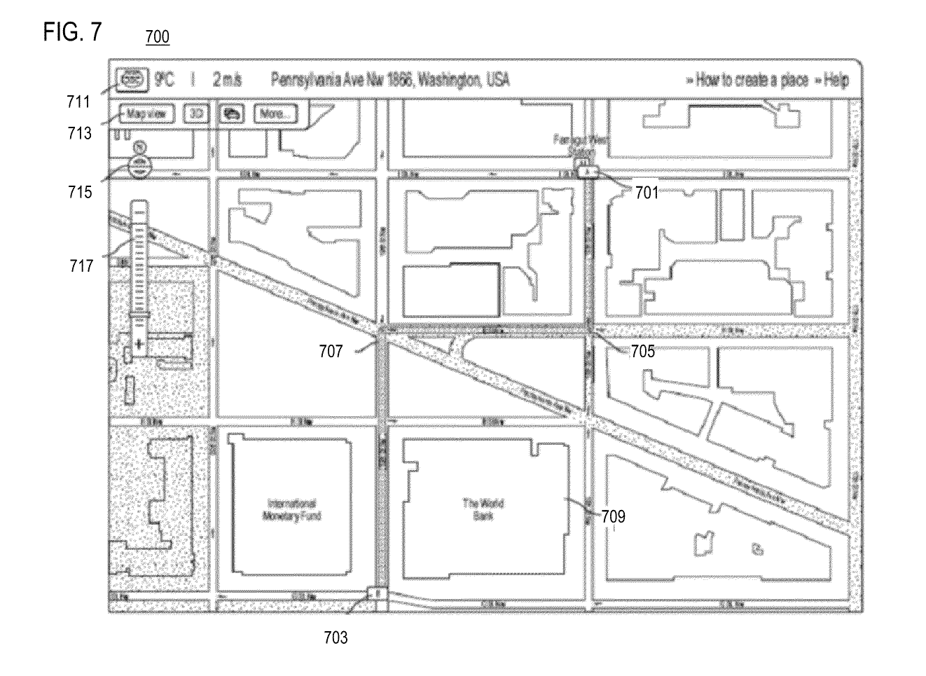

FIG. 7 is a diagram of a 2D digital map for navigation, according to one embodiment. The personalized presentation application 107a provides a 2D digital map 700 on the screen of the UE 101 for the user to indicate on the screen a destination location (e.g., the International Monetary Fund, IMF). By way of example, the user is a foreign banking official plans to visit the IMF for business, by walking from a subway stop to the IMF building. On the way there, the user wants to stop at a bank to exchange US dollars, and to pick up a cup of coffee.

The personalized presentation application 107a then shows in the 2D map 700 a route from the current location (e.g., the Farragut West Metro Station located at 900 18th St. NW Washington D.C. to the destination (e.g., the IMF located at 700 19th St. NW Washington D.C.). By way of example, the personalized presentation application 107a also shows in the map 700 a tab “A” 701 to the current location, a tab “B” 703 to the destination location, a dot 705 at a bank located at the cross section of the H St. and the 18^{th} St., a dot 707 at a convenience store located at the cross section of the H St. and the 19^{th} St., and a point of interest “World Bank” tab 709. On the top of the map, the personalized presentation application 107a shows a bar according the screen 711 including several indicators, such as a weather indicator, the local temperature, etc. The personalized presentation application 107a further shows a shorter bar 713 under the bar 711 including several icons, such as “Map View, “3D”, etc. Below the bar 713, there are a direction icon 715 and a zoom icon 717.

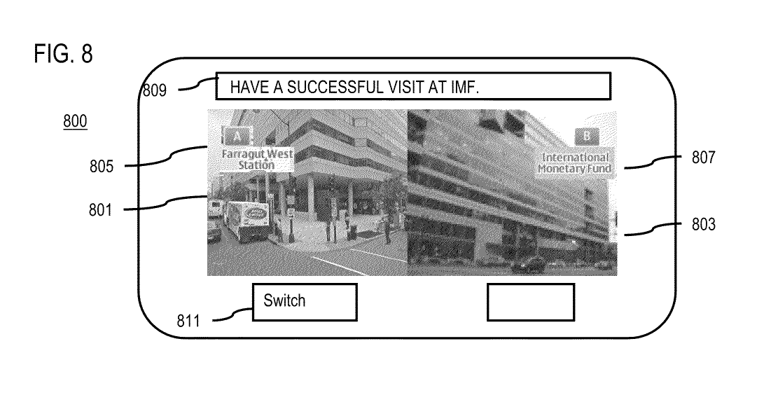

FIG. 8 is a diagram of a user interface utilized in the processes of FIGS. 4 and 5, according to one embodiment. By way of example, after displaying the map with the route in FIG. 7, the personalized presentation application 107a displays a view 800 of the currently location 801 side-by-side with the correlated panoramic image of the destination 803, as well as augmented content 805 (e.g., “Farragut West Station”) with the “A” tab on the live image and augmented content 807 (e.g., “International Monetary Fund”) with the “B” tab on the correlated panoramic image of the destination as shown in FIG. 8.

For example, the text of “Farragut West METRO Station->IMF” may be shown in a bar 809 on the top of the screen of the UE 101 in FIG. 8, while the UE 101a deliveries an audio personalized message of “Have a successful visit at IMF.” If the user only wants to receive visual personalized messages, graphics, images, etc. (e.g., for privacy concerns), the personalized presentation application 107a allows the user to switch between the direction text and a personalized message text in the bar 809 and/or an image, graphic in the view 800, by selecting (e.g., touching, clicking, etc.) a “Switch” icon 811. The personalized presentation application 107a also allows the user to switch between the audio direction and the audio personalized message by selecting the “Switch” icon 811. By way of example, selecting the “Switch” icon 811 triggers a drop-down screen with choices of text switch, audio switch, etc. In other embodiments, the personalized presentation application 107a displays both the direction and personalized message texts, and/or delivers all of the audio direction and personalized message/images/graphics. The personalized presentation application 107a further allows the user to switch on and off the personalized presentation application, by selecting the “Switch” icon 811 for over a predetermined period of time (e.g., 30 seconds).

The above discussed embodiments deliver navigation-based personalized presentations with full personalization of user interaction with navigation devices to provide a more personal and intimate experience. In the above-discussed embodiments, the system refines the user content structure based on usage statistics. Therefore, the user is presented with relevant and tailored personalized presentations. By using location data and preformatted personalized presentations, the above discussed embodiments provide personalized presentations based on navigation information that do not require large amounts of device and/or network resources.

The above discussed embodiments deliver personalized presentations related to the navigation. Besides audio, other forms of media (e.g., text, still images, animation, video, and interactivity content) placed at various navigation devices, user terminals, or other consumer electronics can be used to present the personalized presentations. By way of example, some vehicles have built in navigation systems and TV monitors, such that the personalized presentations can be delivered via the navigation systems and/or TV monitors. The consumer electronics include digital projectors, HDTVs, telephones, MP3 players, audio equipment, calculators, GPS automotive navigation systems, etc. In one embodiment, the consumer electronics are connected to a user terminal where the personalized presentation application resides, or in short range communication (e.g., IR, Bluetooth, etc.) with the user terminal, or a combination thereof.

The processes described herein for providing personalized presentations based on navigation information may be advantageously implemented via software, hardware, firmware or a combination of software and/or firmware and/or hardware. For example, the processes described herein, including for providing user interface navigation information associated with the availability of services, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

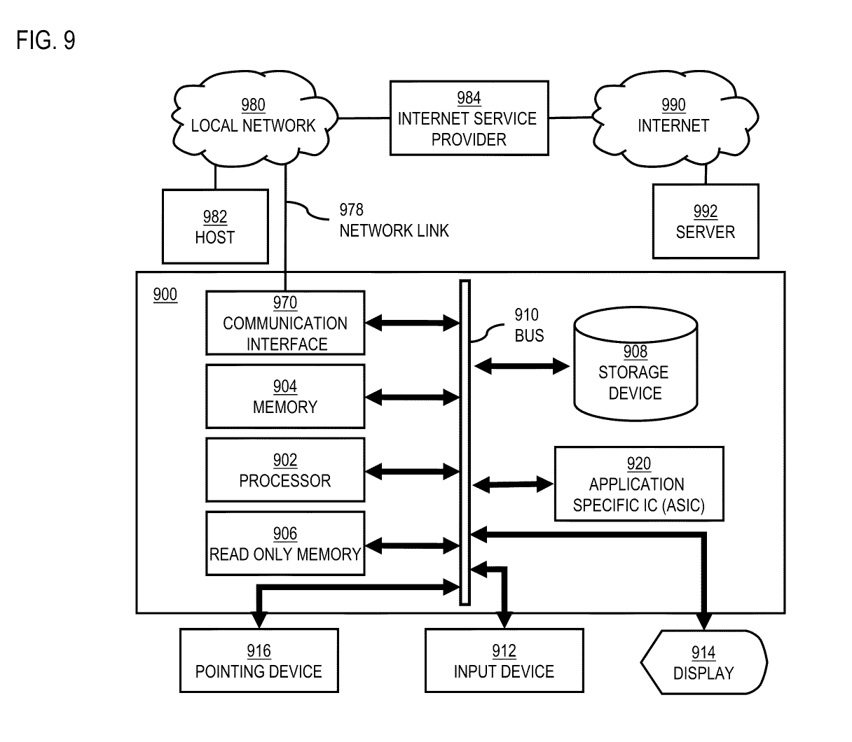

FIG. 9 illustrates a computer system 900 upon which an embodiment of the invention may be implemented. Although computer system 900 is depicted with respect to a particular device or equipment, it is contemplated that other devices or equipment (e.g., network elements, servers, etc.) within FIG. 9 can deploy the illustrated hardware and components of system 900. Computer system 900 is programmed (e.g., via computer program code or instructions) to provide personalized presentations based on navigation information as described herein and includes a communication mechanism such as a bus 910 for passing information between other internal and external components of the computer system 900. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 900, or a portion thereof, constitutes a means for performing one or more steps of providing personalized presentations based on navigation information.

A bus 910 includes one or more parallel conductors of information so that information is transferred quickly among devices coupled to the bus 910. One or more processors 902 for processing information are coupled with the bus 910.

A processor (or multiple processors) 902 performs a set of operations on information as specified by computer program code related to provide personalized presentations based on navigation information. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 910 and placing information on the bus 910. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 902, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 900 also includes a memory 904 coupled to bus 910. The memory 904, such as a random access memory (RAM) or other dynamic storage device, stores information including processor instructions for providing personalized presentations based on navigation information. Dynamic memory allows information stored therein to be changed by the computer system 900. RAM allows a unit of information stored at a location called a memory address to be stored and retrieved independently of information at neighboring addresses. The memory 904 is also used by the processor 902 to store temporary values during execution of processor instructions. The computer system 900 also includes a read only memory (ROM) 906 or other static storage device coupled to the bus 910 for storing static information, including instructions, that is not changed by the computer system 900. Some memory is composed of volatile storage that loses the information stored thereon when power is lost. Also coupled to bus 910 is a non-volatile (persistent) storage device 908, such as a magnetic disk, optical disk or flash card, for storing information, including instructions, that persists even when the computer system 900 is turned off or otherwise loses power.

Information, including instructions for providing personalized presentations based on navigation information, is provided to the bus 910 for use by the processor from an external input device 912, such as a keyboard containing alphanumeric keys operated by a human user, or a sensor. A sensor detects conditions in its vicinity and transforms those detections into physical expression compatible with the measurable phenomenon used to represent information in computer system 900. Other external devices coupled to bus 910, used primarily for interacting with humans, include a display device 914, such as a cathode ray tube (CRT) or a liquid crystal display (LCD), or plasma screen or printer for presenting text or images, and a pointing device 916, such as a mouse or a trackball or cursor direction keys, or motion sensor, for controlling a position of a small cursor image presented on the display 914 and issuing commands associated with graphical elements presented on the display 914. In some embodiments, for example, in embodiments in which the computer system 900 performs all functions automatically without human input, one or more of external input device 912, display device 914 and pointing device 916 is omitted.

In the illustrated embodiment, special purpose hardware, such as an application specific integrated circuit (ASIC) 920, is coupled to bus 910. The special purpose hardware is configured to perform operations not performed by processor 902 quickly enough for special purposes. Examples of application specific ICs include graphics accelerator cards for generating images for display 914, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 900 also includes one or more instances of a communications interface 970 coupled to bus 910. Communication interface 970 provides a one-way or two-way communication coupling to a variety of external devices that operate with their own processors, such as printers, scanners and external disks. In general the coupling is with a network link 978 that is connected to a local network 980 to which a variety of external devices with their own processors are connected. For example, communication interface 970 may be a parallel port or a serial port or a universal serial bus (USB) port on a personal computer. In some embodiments, communications interface 970 is an integrated services digital network (ISDN) card or a digital subscriber line (DSL) card or a telephone modem that provides an information communication connection to a corresponding type of telephone line. In some embodiments, a communication interface 970 is a cable modem that converts signals on bus 910 into signals for a communication connection over a coaxial cable or into optical signals for a communication connection over a fiber optic cable. As another example, communications interface 970 may be a local area network (LAN) card to provide a data communication connection to a compatible LAN, such as Ethernet. Wireless links may also be implemented. For wireless links, the communications interface 970 sends or receives or both sends and receives electrical, acoustic or electromagnetic signals, including infrared and optical signals, that carry information streams, such as digital data. For example, in wireless handheld devices, such as mobile telephones like cell phones, the communications interface 970 includes a radio band electromagnetic transmitter and receiver called a radio transceiver. In certain embodiments, the communications interface 970 enables connection from the UE 101 to the communication network 105 for providing personalized presentations based on navigation information.

The term “computer-readable medium” as used herein refers to any medium that participates in providing information to processor 902, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 908. Volatile media include, for example, dynamic memory 904. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 920.

Network link 978 typically provides information communication using transmission media through one or more networks to other devices that use or process the information. For example, network link 978 may provide a connection through local network 980 to a host computer 982 or to equipment 984 operated by an Internet Service Provider (ISP). ISP equipment 984 in turn provides data communication services through the public, world-wide packet-switching communication network of networks now commonly referred to as the Internet 990.

A computer called a server host 992 connected to the Internet hosts a process that provides a service in response to information received over the Internet. For example, server host 992 hosts a process that provides information representing video data for presentation at display 914. It is contemplated that the components of system 900 can be deployed in various configurations within other computer systems, e.g., host 982 and server 992.

At least some embodiments of the invention are related to the use of computer system 900 for implementing some or all of the techniques described herein. According to one embodiment of the invention, those techniques are performed by computer system 900 in response to processor 902 executing one or more sequences of one or more processor instructions contained in memory 904. Such instructions, also called computer instructions, software and program code, may be read into memory 904 from another computer-readable medium such as storage device 908 or network link 978. Execution of the sequences of instructions contained in memory 904 causes processor 902 to perform one or more of the method steps described herein. In alternative embodiments, hardware, such as ASIC 920, may be used in place of or in combination with software to implement the invention. Thus, embodiments of the invention are not limited to any specific combination of hardware and software, unless otherwise explicitly stated herein.

The signals transmitted over network link 978 and other networks through communications interface 970, carry information to and from computer system 900. Computer system 900 can send and receive information, including program code, through the networks 980, 990 among others, through network link 978 and communications interface 970. In an example using the Internet 990, a server host 992 transmits program code for a particular application, requested by a message sent from computer 900, through Internet 990, ISP equipment 984, local network 980 and communications interface 970. The received code may be executed by processor 902 as it is received, or may be stored in memory 904 or in storage device 908 or other non-volatile storage for later execution, or both. In this manner, computer system 900 may obtain application program code in the form of signals on a carrier wave.

Various forms of computer readable media may be involved in carrying one or more sequence of instructions or data or both to processor 902 for execution. For example, instructions and data may initially be carried on a magnetic disk of a remote computer such as host 982. The remote computer loads the instructions and data into its dynamic memory and sends the instructions and data over a telephone line using a modem. A modem local to the computer system 900 receives the instructions and data on a telephone line and uses an infra-red transmitter to convert the instructions and data to a signal on an infra-red carrier wave serving as the network link 978. An infrared detector serving as communications interface 970 receives the instructions and data carried in the infrared signal and places information representing the instructions and data onto bus 910. Bus 910 carries the information to memory 904 from which processor 902 retrieves and executes the instructions using some of the data sent with the instructions. The instructions and data received in memory 904 may optionally be stored on storage device 908, either before or after execution by the processor 902.

FIG. 10 illustrates a chip set or chip 1000 upon which an embodiment of the invention may be implemented. Chip set 1000 is programmed to provide personalized presentations based on navigation information as described herein and includes, for instance, the processor and memory components described with respect to FIG. 9 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 1000 can be implemented in a single chip. It is further contemplated that in certain embodiments the chip set or chip 1000 can be implemented as a single “system on a chip.” It is further contemplated that in certain embodiments a separate ASIC would not be used, for example, and that all relevant functions as disclosed herein would be performed by a processor or processors. Chip set or chip 1000, or a portion thereof, constitutes a means for performing one or more steps of providing user interface navigation information associated with the availability of services. Chip set or chip 1000, or a portion thereof, constitutes a means for performing one or more steps of providing personalized presentations based on navigation information.

In one embodiment, the chip set or chip 1000 includes a communication mechanism such as a bus 1001 for passing information among the components of the chip set 1000. A processor 1003 has connectivity to the bus 1001 to execute instructions and process information stored in, for example, a memory 1005. The processor 1003 may include one or more processing cores with each core configured to perform independently. A multi-core processor enables multiprocessing within a single physical package. Examples of a multi-core processor include two, four, eight, or greater numbers of processing cores. Alternatively or in addition, the processor 1003 may include one or more microprocessors configured in tandem via the bus 1001 to enable independent execution of instructions, pipelining, and multithreading. The processor 1003 may also be accompanied with one or more specialized components to perform certain processing functions and tasks such as one or more digital signal processors (DSP) 1007, or one or more application-specific integrated circuits (ASIC) 1009. A DSP 1007 typically is configured to process real-world signals (e.g., sound) in real time independently of the processor 1003. Similarly, an ASIC 1009 can be configured to performed specialized functions not easily performed by a more general purpose processor. Other specialized components to aid in performing the inventive functions described herein may include one or more field programmable gate arrays (FPGA) (not shown), one or more controllers (not shown), or one or more other special-purpose computer chips.

In one embodiment, the chip set or chip 1000 includes merely one or more processors and some software and/or firmware supporting and/or relating to and/or for the one or more processors.

The processor 1003 and accompanying components have connectivity to the memory 1005 via the bus 1001. The memory 1005 includes both dynamic memory (e.g., RAM, magnetic disk, writable optical disk, etc.) and static memory (e.g., ROM, CD-ROM, etc.) for storing executable instructions that when executed perform the inventive steps described herein to provide personalized presentations based on navigation information. The memory 1005 also stores the data associated with or generated by the execution of the inventive steps.

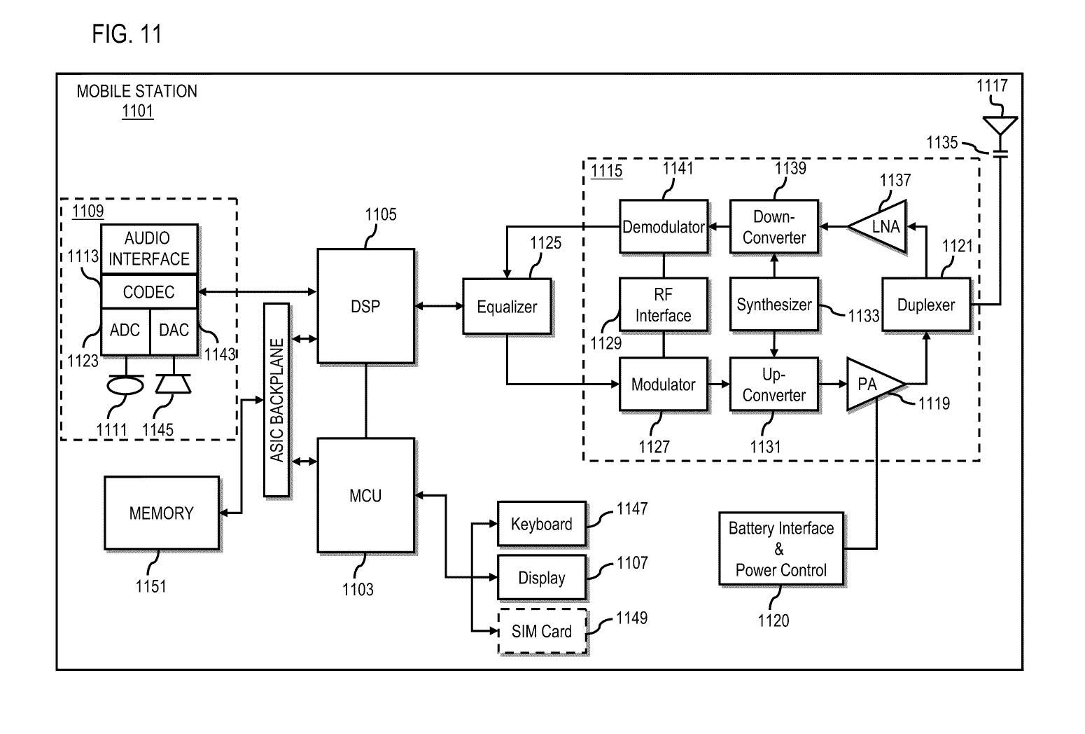

FIG. 11 is a diagram of exemplary components of a mobile terminal (e.g., handset) for communications, which is capable of operating in the system of FIG. 1, according to one embodiment. In some embodiments, mobile terminal 1100, or a portion thereof, constitutes a means for performing one or more steps of providing personalized presentations based on navigation information. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1103, a Digital Signal Processor (DSP) 1105, and a receiver/transmitter unit including a microphone gain control unit and a speaker gain control unit. A main display unit 1107 provides a display to the user in support of various applications and mobile terminal functions that perform or support the steps of providing personalized presentations based on navigation information. The display 11 includes display circuitry configured to display at least a portion of a user interface of the mobile terminal (e.g., mobile telephone). Additionally, the display 1107 and display circuitry are configured to facilitate user control of at least some functions of the mobile terminal. An audio function circuitry 1109 includes a microphone 1111 and microphone amplifier that amplifies the speech signal output from the microphone 1111. The amplified speech signal output from the microphone 1111 is fed to a coder/decoder (CODEC) 1113.

A radio section 1115 amplifies power and converts frequency in order to communicate with a base station, which is included in a mobile communication system, via antenna 1117. The power amplifier (PA) 1119 and the transmitter/modulation circuitry are operationally responsive to the MCU 1103, with an output from the PA 1119 coupled to the duplexer 1121 or circulator or antenna switch, as known in the art. The PA 1119 also couples to a battery interface and power control unit 1120.

In use, a user of mobile terminal 1101 speaks into the microphone 1111 and his or her voice along with any detected background noise is converted into an analog voltage. The analog voltage is then converted into a digital signal through the Analog to Digital Converter (ADC) 1123. The control unit 1103 routes the digital signal into the DSP 1105 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like.

The encoded signals are then routed to an equalizer 1125 for compensation of any frequency-dependent impairments that occur during transmission though the air such as phase and amplitude distortion. After equalizing the bit stream, the modulator 1127 combines the signal with a RF signal generated in the RF interface 1129. The modulator 1127 generates a sine wave by way of frequency or phase modulation. In order to prepare the signal for transmission, an up-converter 1131 combines the sine wave output from the modulator 1127 with another sine wave generated by a synthesizer 1133 to achieve the desired frequency of transmission. The signal is then sent through a PA 1119 to increase the signal to an appropriate power level. In practical systems, the PA 1119 acts as a variable gain amplifier whose gain is controlled by the DSP 1105 from information received from a network base station. The signal is then filtered within the duplexer 1121 and optionally sent to an antenna coupler 1135 to match impedances to provide maximum power transfer. Finally, the signal is transmitted via antenna 1117 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile terminal 1101 are received via antenna 1117 and immediately amplified by a low noise amplifier (LNA) 1137. A down-converter 1139 lowers the carrier frequency while the demodulator 1141 strips away the RF leaving only a digital bit stream. The signal then goes through the equalizer 1125 and is processed by the DSP 1105. A Digital to Analog Converter (DAC) 1143 converts the signal and the resulting output is transmitted to the user through the speaker 1145, all under control of a Main Control Unit (MCU) 1103—which can be implemented as a Central Processing Unit (CPU) (not shown).

The MCU 1103 receives various signals including input signals from the keyboard 1147. The keyboard 1147 and/or the MCU 1103 in combination with other user input components (e.g., the microphone 1111) comprise a user interface circuitry for managing user input. The MCU 1103 runs a user interface software to facilitate user control of at least some functions of the mobile terminal 1101 to provide personalized presentations based on navigation information. The MCU 1103 also delivers a display command and a switch command to the display 1107 and to the speech output switching controller, respectively. Further, the MCU 1103 exchanges information with the DSP 1105 and can access an optionally incorporated SIM card 1149 and a memory 1151. In addition, the MCU 1103 executes various control functions required of the terminal. The DSP 1105 may, depending upon the implementation, perform any of a variety of conventional digital processing functions on the voice signals. Additionally, DSP 1105 determines the background noise level of the local environment from the signals detected by microphone 1111 and sets the gain of microphone 1111 to a level selected to compensate for the natural tendency of the user of the mobile terminal 1101.

The CODEC 1113 includes the ADC 1123 and DAC 1143. The memory 1151 stores various data including call incoming tone data and is capable of storing other data including music data received via, e.g., the global Internet. The software module could reside in RAM memory, flash memory, registers, or any other form of writable storage medium known in the art. The memory device 1151 may be, but not limited to, a single memory, CD, DVD, ROM, RAM, EEPROM, optical storage, or any other non-volatile storage medium capable of storing digital data.

An optionally incorporated SIM card 1149 carries, for instance, important information, such as the cellular phone number, the carrier supplying service, subscription details, and security information. The SIM card 1149 serves primarily to identify the mobile terminal 1101 on a radio network. The card 1149 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A method comprising:
determining one or more points of interest associated with a navigation;
generating one or more presentations personal to a user of the navigation based, at least in part, on the points of interest, wherein the one or more presentations supplement navigation guidance information associated with the navigation; and
causing, at least in part, rendering of the one or more presentations.

2. A method of claim 1, further comprising:
retrieving one or more predetermined phrases associated with the one or more points of interest; and
retrieving one or more names corresponding to the one or more points of interest,
wherein the generating of the one or more presentations is based, at least in part, on the predetermined phrases, the names, or a combination thereof.

3. A method of claim 1, further comprising:
mapping one or more routes of the navigation to a database;
retrieving the points of interest from the database based, at least in part, on the routes; and
ranking the points of interest based, at least in part, on a user navigation history, one or more user activities that have occurred at the points of interest, user preferences, or a combination thereof.

4. A method of claim 3, further comprising:
selecting a predetermined number of the points of interest based, at least in part, on the ranking, wherein the generating of the one or more presentations comprises generating respective one or more presentations for corresponding selected points of interest; and
causing, at least in part, rendering of the respective one or more presentations when approaching the corresponding selected points of interest.

5. A method of claim 4, further comprising:
retrieving one or more potential user activities associated with the corresponding selected points of interest;
ranking the potential user activities based, at least in part, on user activities that have occurred at the corresponding selected points of interest, user preferences, user calendars, recent text messages, recent instant messages, or a combination thereof; and
selecting a predetermined number of the potential user activities based, at least in part, on the ranking of the potential user activities,
wherein the generating of the one or more presentations comprises generating respective one or more presentations for corresponding selected potential user activities.

6. A method of claim 3, wherein the user navigation history includes, at least in part, data on a set of points of interests visited or approached by the user.

7. A method of claim 6, further comprising:
retrieving sensor data associated with one or more user activities conducted at one or more points of interest in the set,
wherein the user activities that have occurred at the points of interest includes, at least in part, the sensor data.

8. A method of claim 1, wherein the one or more presentations relate to a characteristic of the points of the interest, one or more potential activities conducted at the points of interest, the user, or a combination thereof.

9. A method of claim 1, wherein the one or more presentations comprise one or more messages, items, media objects, or a combination thereof.

10. An apparatus comprising:
at least one processor; and
at least one memory including computer program code for one or more programs,
the at least one memory and the computer program code configured to, with the at least one processor, cause the apparatus to perform at least the following, determine one or more points of interest associated with a navigation;
generate one or more presentations personal to a user of the navigation based, at least in part, on the points of interest, wherein the one or more presentations supplement navigation guidance information associated with the navigation; and
cause, at least in part, rendering of the one or more presentations.

11. An apparatus of claim 10, wherein the apparatus is further caused to:
retrieve one or more predetermined phrases associated with the one or more points of interest; and
retrieve one or more names corresponding to the one or more points of interest, wherein the one or more presentations are generated based, at least in part, on the predetermined phrases, the names, or a combination thereof.

12. An apparatus of claim 10, wherein the apparatus is further caused to:
map one or more routes of the navigation to a database;
retrieve the points of interest from the database based, at least in part, on the routes; and
rank the points of interest based, at least in part, on a user navigation history, one or more user activities that have occurred at the points of interest, user preferences, or a combination thereof.

13. An apparatus of claim 12, wherein the apparatus is further caused to:
select a predetermined number of the points of interest based, at least in part, on the ranking, wherein the generating of the one or more presentations comprises generating respective one or more presentations for corresponding selected points of interest; and
cause, at least in part, rendering of the respective one or more presentations when approaching the corresponding selected points of interest during the navigation.

14. An apparatus of claim 13, wherein the apparatus is further caused to:
retrieve one or more potential user activities associated with the corresponding selected points of interest;
rank the potential user activities based, at least in part, on user activities that have occurred at the corresponding selected points of interest, user preferences, user calendars, recent text messages, recent instant messages, or a combination thereof; and
select a predetermined number of the potential user activities based, at least in part, on the ranking of the potential user activities,
wherein the one or more presentations are generated for corresponding selected potential user activities.

15. An apparatus of claim 12, wherein the user navigation history includes, at least in part, data on a set of points of interests visited or approached by the user.

16. An apparatus of claim 15, wherein the apparatus is further caused to:
retrieve sensor data associated with one or more user activities conducted at one or more points of interest in the set,
wherein the user activities that have occurred at the points of interest includes, at least in part, the sensor data.

17. An apparatus of claim 10, wherein the one or more presentations relate to a characteristic of the points of the interest, one or more potential activities conducted at the points of interest, the user, or a combination thereof.

18. A computer-readable storage medium carrying one or more sequences of one or more instructions which, when executed by one or more processors, cause an apparatus to at least perform the following steps:
determining one or more points of interest associated with a navigation;
generating one or more presentations personal to a user of the navigation based, at least in part, on the points of interest, wherein the one or more presentations supplement navigation guidance information associated with the navigation; and
causing, at least in part, rendering of the one or more presentations.

19. A computer-readable storage medium of claim 18, wherein the apparatus is caused to further perform:
retrieving one or more predetermined phrases associated with the one or more points of interest; and
retrieving one or more names corresponding to the one or more points of interest,
wherein the one or more presentations are generated based, at least in part, on the predetermined phrases, the names, or a combination thereof.

20. A computer-readable storage medium of claim 18, wherein the apparatus is caused to further perform:
mapping one or more routes of the navigation to a database;
retrieving the points of interest from the database based, at least in part, on the routes; and
ranking the points of interest based, at least in part, on a user navigation history, one or more user activities that have occurred at the points of interest, user preferences, or a combination thereof.

21-56. (canceled)
